(19) United States
(12) Patent Application Publication
(10) Pub. No.: US 2023/0184969 A1
(43) Pub. Date: Jun. 15, 2023

(54) UNMANNED REMOTE RADIATION DETECTOR

(71) Applicant: GIMCHEON UNIVERSITY INDUSTRY ACADEMY COOPERATION FOUNDATION, Gimcheon-si, Gyeongsangbuk-do (KR)

(72) Inventor: Bo Seok CHANG, Busan (KR)

(73) Assignee: GIMCHEON UNIVERSITY INDUSTRY ACADEMY COOPERATION FOUNDATION, Gimcheon-si, Gyeongsangbuk-do (KR)

(21) Appl. No.: 17/923,656

(22) PCT Filed: May 14, 2021
(86) PCT No.: PCT/KR2021/006046

§ 371 Date: Nov. 7, 2022

(30) Foreign Application Priority Data
May 18, 2020 (KR) 10-2020-0058962

(51) Int. Cl. G01T 7/00; G01T 1/202; B64U 20/87; F16M 11/20

(52) U.S. Cl. CPC G01T 7/00; G01T 1/2023; B64U 20/87; F16M 11/2042; B64U 2101/30

(57) ABSTRACT

The present invention relates to an unmanned remote radiation detector capable of accurately detecting radiation radiating in different directions by approaching a place, where the radiation leaks, from above by the control of a user, the unmanned remote radiation detector having: an unmanned aircraft controlled by the user to fly above a nuclear power facility; and a detection part position adjustment part which is coupled to the unmanned aircraft, enables distance adjustment so as to bring a radiation detection part provided on one side thereof near the nuclear power facility, and orients the radiation detection part toward the nuclear power facility by driving same to incline forward, backward, left and right.

### TECHNICAL FIELD

The present disclosure relates to a radiation detector capable of remotely detecting radiation in areas even without being accessed by people and, more particularly, to an unmanned remote radiation detector capable of accurately detecting, under control of a user, radiation radiating in all directions by accessing a nuclear facility, which leaks the radiation, from the sky.

### BACKGROUND ART

In order to ensure environmental safety of a nuclear facility such as a nuclear power plant and a radioactive waste site, radiation detection is conducted within the surrounding area of the nuclear facility.

The radiation detection uses methods, including: a fixed detection method in which a radiation detection part is installed in a fixed place to detect radiation; and a mobile detection method in which a detection sensor is mounted in a moving means such as a vehicle or backpack to detect radiation. Since the fixed detection method is capable of detecting only within a radius where a detection sensor is installed, it is difficult to accurately detect radiation leaking from a nuclear facility, so the mobile detection method is mainly used.

However, even when a detection sensor is installed in a vehicle and the like, it is difficult to access a place high above the ground, such as a high floor, a railing, or the like, and it is impossible for a person to access to a facility where leaking of high-level radiation is suspected. Even when low-level radiation is leaked, the risk of radiation exposure always exists, and thus a detector capable of detecting radioactivity in areas even without being accessed by people is required.

In addition, as for radiation radiating in all directions from a site where radioactive waste is placed, there is a difference in the amount of detected radiation depending on angles incident on a surface of the detector such as a sensor. For this reason, the amount of radiation detected is different depending on orientation positions or detection distances of the detector, and also when radiation is radiated in minute amounts, it is difficult to detect the radiation unless the radiation is incident perpendicular to the detector.

### DOCUMENTS OF RELATED ART

### Patent Documents

(Patent Document 1) Korean Patent Application Publication No. 10-2019-0124915 (Invention title: MOVABLE APPARATUS FOR DETECTING RADIATION, METHOD OF DETECTING RADIATION MOVABLY AND COMPUTER READABLE MEDIUM)

### DISCLOSURE

### Technical Problem

Accordingly, the present disclosure has been devised to solve such a problem, and an objective of the present disclosure is to provide an unmanned remote radiation detector capable of safely detecting leaking radiation remotely in areas even without being accessed by people.

### Technical Solution

In order to solve the above technical problems, the present disclosure provides an unmanned remote radiation detector, including: an unmanned aerial vehicle controlled by a user and flown over the nuclear facility; and a position adjustment unit configured to couple to the unmanned aerial vehicle and for adjusting a position of a radiation detection part provided on one side of the position adjustment unit, the unit adjusting a distance to make the radiation detection part approach to the nuclear facility and directing the radiation detection part toward the nuclear facility by driving the radiation detection part to be inclined back and forth, left and right.

In the present disclosure, the position adjustment unit may include: a seating plate on which the radiation detection part is seated on a front side thereof; and a plurality of directing cylinders configured to connect the unmanned aerial vehicle and the seating plate and to be linearly extendable.

In the present disclosure, each directing cylinder may be spaced apart from each other along a rear edge of the seating plate and disposed on a circumference having a predetermined radius.

In the present disclosure, one end of each directing cylinder may be coupled to one neighboring directing cylinder on side of the unmanned aerial vehicle and extend obliquely, and the other end of each directing cylinder may be coupled to another directing cylinder on side of the seating plate.

In the present disclosure, the position adjustment part may further include: link parts in which both ends of the directing cylinder are rotatably connected to the unmanned aerial vehicle and the seating plate, respectively.

In the present disclosure, the unmanned aerial vehicle may further include a communication unit configured to wirelessly receive a driving control command of each directing cylinder from the user.

### Advantageous Effects

According to the present disclosure, the embodiment of the present disclosure may detect radiation without the risk of radiation exposure, may easily access, from the sky, an area in which the radiation leaks by a remotely controlling user, so as to readily detect the radiation occurring in the areas inaccessible to people, and particularly, may enable the user to freely adjust orientation angles and detection distances of a radiation detection part to accurately detect the amount of radiation leaking in all directions. Therefore, the user may accurately detect the radiation leaking place as well as the minute leaking radiation, so that the embodiment of the present disclosure may be valuably used for decommissioning work of nuclear facilities, etc.

### DESCRIPTION OF DRAWINGS

FIG. 1 is a perspective view illustrating an unmanned remote radiation detector according to the present disclosure.

FIG. 2 is a block diagram illustrating a configuration of an unmanned aerial vehicle.

FIG. 3 is a perspective view illustrating a position adjustment unit of the present disclosure.

FIG. 4 is an exploded perspective view illustrating a link part of the present disclosure.

FIG. 5 is a view illustrating a length adjustment operation of the position adjustment unit according to the present disclosure.

FIG. 6 is a view illustrating an orientation angle operation of the position adjustment unit of the present disclosure.

### BEST MODE

Hereinafter, an exemplary embodiment of the present disclosure will be described in detail with reference to the accompanying drawings.

The present exemplary embodiment is provided to more completely describe the present disclosure to those skilled in the art, and the shapes of components, the sizes of the components, the spacing between the components, etc., in the drawings may be exaggerated or reduced to emphasize a clearer description.

In addition, in describing the exemplary embodiment, when a component is described as being “formed”, “included”, “coupled”, or “fixed” to another component, that component may be directly formed, included, coupled, or fixed to that other component. However, it should be understood that yet another component between each of the components may also be present.

In addition, in describing the exemplary embodiment, as a matter already known to those skilled in the art such as a related known function or known configuration in principle, when it is determined that the technical features of the present disclosure may be unnecessarily obscured, a detailed description thereof will be omitted.

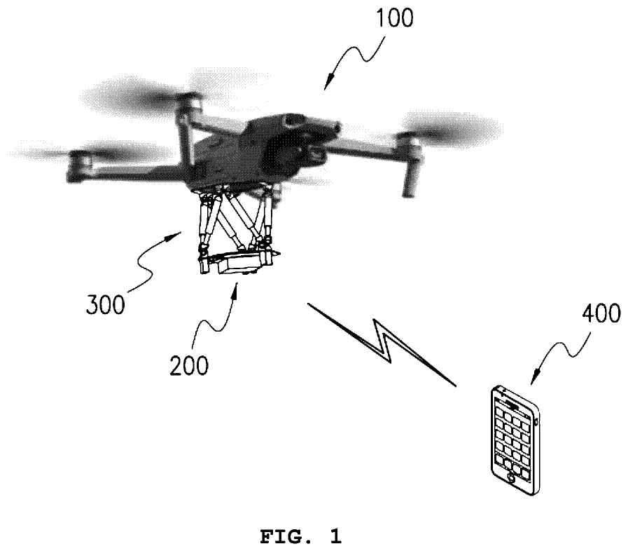

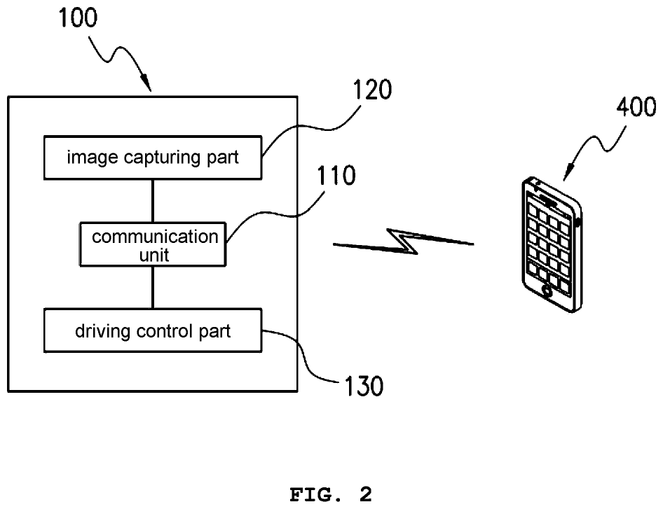

FIG. 1 is a perspective view illustrating an unmanned remote radiation detector according to the present disclosure, and FIG. 2 is a block diagram illustrating a configuration of an unmanned aerial vehicle 100. Referring to FIGS. 1 and 2, the present disclosure includes: an unmanned aerial vehicle 100 controlled wirelessly by a user's control terminal 400 and flyable over a nuclear facility leaking radiation; a radiation detection part 200 provided at a lower part of the unmanned aerial vehicle 100 to be able to detect the leaking radiation; and a position adjustment unit 300 mounted on a lower side of the radiation detection part 200.

The unmanned aerial vehicle 100 is an air plane without a person on board, is connected to the user's control terminal 400 through a wireless network to control operations on whether to fly or not, flight routes, information transmission, etc., and is configured to detect leaking radiation while flying over a target nuclear facility.

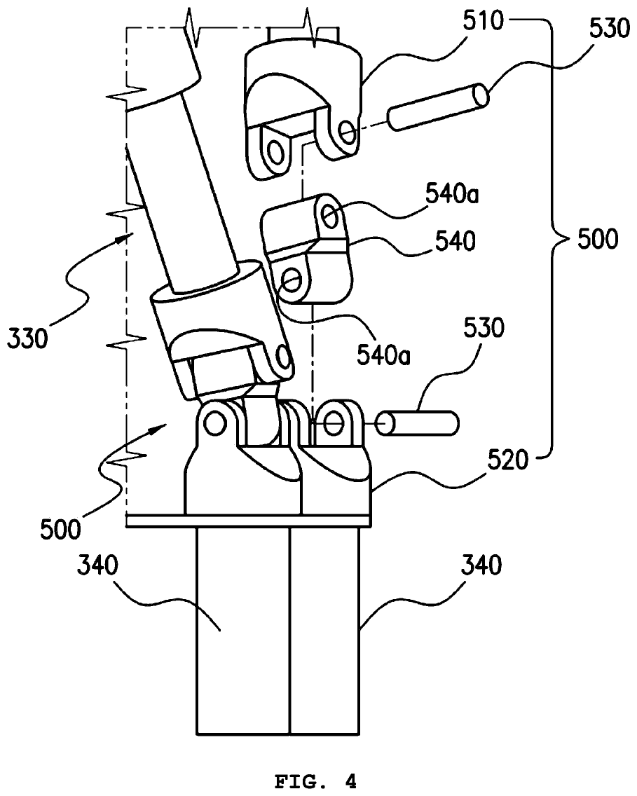

The configuration of the unmanned aerial vehicle 100 is illustrated in FIG. 2, and the unmanned aerial vehicle 100 is provided with a communication unit 110, an image capturing part 120, and a driving control part 130 configured to control an operation of the position adjustment unit 300. The communication unit 110 is a component provided for wireless communication with the control terminal 400, and may include a transmitting antenna, a receiving antenna, and an RF circuit capable of implementing various communication protocols. The image capturing part 120 is composed of a camera, so as to obtain image information of a flight area where radiation is detected, and the obtained information in this way is transmitted to the control terminal 400 through the communication unit 110. The driving control part 130 receives a driving control command transmitted from the control terminal 400 for the position adjustment unit 300, so as to control driving of driving motors (340 in FIG. 4), which will be described later. The unmanned aerial vehicle 100 may further include a Global Positioning System (GPS) sensor to determine a current location.

The radiation detection part 200 is formed in a shape of a plate having a predetermined thickness, and is configured to include: a radiation detection sensor made of a scintillator material such as Nal or LaBr₃, or a semiconductor material such as silicon (Si), high-purity germanium (HPGe), or gallium arsenide (GaAs); and a radiation amount calculation part for calculating an amount of radiation detected by the radiation detection sensor. The radiation detection sensor is horizontally disposed on a front side of the radiation detection part 200 to detect radiation incident from the outside, and the radiation amount calculation part may calculate a cumulative amount of radiation as an amount of radiation for a preset time, and may also calculate the amount of radiation in real time. The amount of radiation detected in this way is transmitted to the control terminal 400.

The position adjustment unit 300 is configured to seat the radiation detection part 200 on a lower side thereof to mount the radiation detection part 200 on a lower part of the unmanned aerial vehicle 100, and is provided to adjust distances so that the radiation detection part 200 approaches to a nuclear facility and to adjust angles so that the front side of the radiation detection part 200 is oriented in a direction in which radiation leaks.

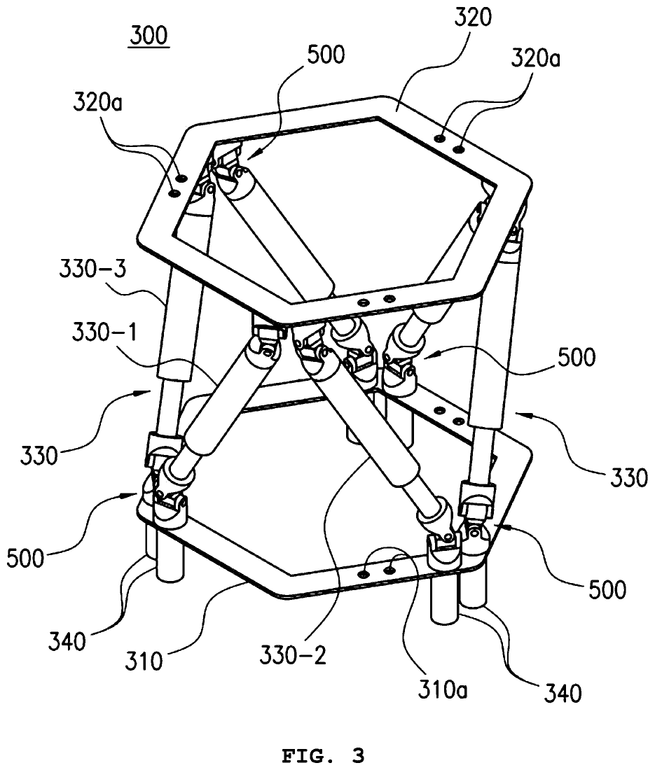

Referring to the position adjustment unit 300 illustrated in FIG. 3, the position adjustment unit 300 includes: a seating plate 310 on which the radiation detection part 200 is mounted on a front side thereof; an unmanned aerial vehicle coupling plate 320 provided to face the seating plate 310; and a plurality of directing cylinders 330 configured to connect the seating plate 310 and the unmanned aerial vehicle coupling plate 320 to each other.

A plurality of through-holes 310a and 320a to which bolts and nuts are fastened are formed in the seating plate 310 and the unmanned aerial vehicle coupling plate 320, and the radiation detection part 200 and the unmanned aerial vehicle 100 are combined into and fixedly seated in the respective through-holes.

Each directing cylinder 330 has opposite ends thereof respectively coupled to the seating plate 310 and the unmanned aerial vehicle coupling plate 320, and has a length thereof extending in a straight direction by a driving motor 340 controlled by the above-described driving control part 300.

The plurality of directing cylinders 330 is arranged on a circumference having a predetermined radius of each edge of the seating plate 310 and the unmanned aerial vehicle coupling plate 320, and is extended in an oblique line along a vertical direction as shown in FIG. 3. Accordingly, as a pair on the unmanned aerial vehicle coupling plate 320, one end of each directing cylinder 330-1 is disposed to be connected to one neighboring directing cylinder 330-2 and extends obliquely toward the seating plate 310, and as a pair on the seating plate 310, the other end of each directing cylinder is disposed to be coupled to another directing cylinder 330-3.

In addition, as shown in FIG. 4, link parts 500 are respectively provided at opposite ends of each directing cylinder 330 connected to the seating plate 310 and the unmanned aerial vehicle coupling plate 320. The link parts 500 include: first connectors 510 provided at opposite ends of each directing cylinder 330; second connectors 520 formed to protrude respectively from the seating plate 310 and the unmanned aerial vehicle coupling plate 320; and link bodies 540 configured to combine the first connectors 510 and the second connectors 520 by respectively inserting link pins 530 into link holes 540a, which are formed to be spaced apart from each other at an upper part and a lower part of each link body and are formed to be perpendicular to each other on a vertical extension line. Accordingly, the opposite ends of each directing cylinder 330 are freely rotatable by the link parts 500 formed in this way.

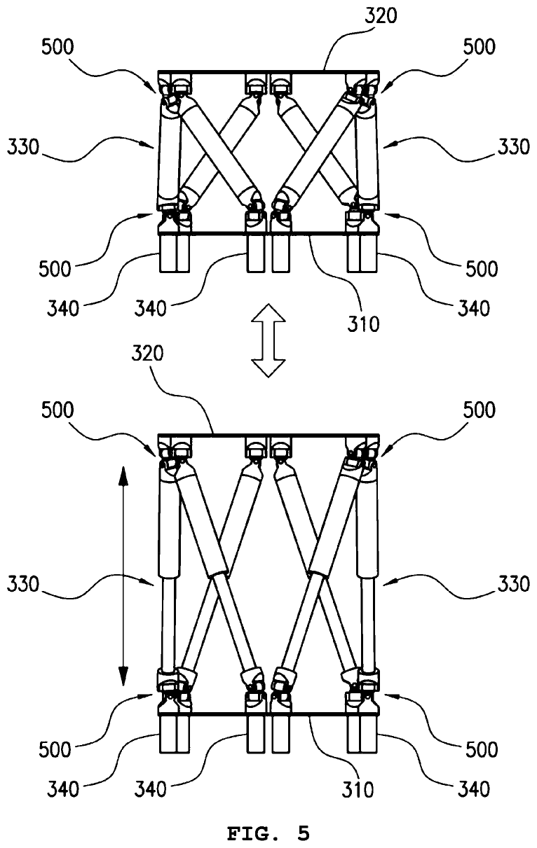

Each directing cylinder 330 provided in this way is individually controlled by the driving motor 340. When the plurality of directing cylinders 330 is extended to the same length, each directing cylinder is extended downward as shown in FIG. 5, so that the radiation detection part 200 seated on the seating plate 310 may be closer to a place in which radiation is leaked, whereby the amount of leaked radiation may be detected more accurately.

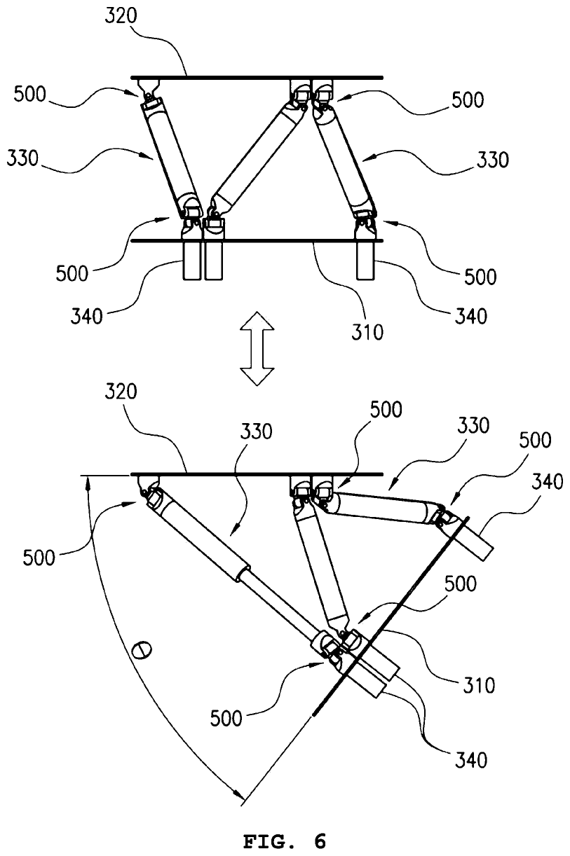

In addition, when extension lengths of the plurality of disposed directing cylinders 330 are made different, the seating plate 310 may be oriented in an inclined manner. FIG. 6 illustrates a case in which one directing cylinder 330 arranged on the left is extended on a horizontal plane and another directing cylinder 330 arranged on the right is not extended, and thus the seating plate 310 is inclined at a predetermined orientation angle θ on the horizontal plane. As such, when the extension lengths of the plurality of directing cylinders 330 disposed on the circumference and extending in the oblique direction are made different from each other, the seating plate 310 may be freely inclinedly driven back and forth, left and right.

Therefore, a user may freely orient the radiation detection part 200 to a position where the incident angle of radiation is vertical, so that the amount of radiation leaking in all directions may be accurately detected, whereby the leaking location as well as the minute leaking radiation may be accurately detected.

The present disclosure described above is not limited to the described exemplary embodiment, and it is apparent to those skilled in the art that various modifications and variations can be made without departing from the spirit and scope of the present disclosure. Accordingly, it should be said that such examples of variations or modifications fall within the scope of the claims of the present disclosure.

1. An unmanned remote radiation detector for detecting radiation leaking from a nuclear facility, the detector comprising:
an unmanned aerial vehicle controlled by a user and flown over the nuclear facility; and
a position adjustment unit configured to couple to the unmanned aerial vehicle and for adjusting a position of a radiation detection part provided on one side of the position adjustment unit, the unit adjusting a distance to make the radiation detection part approach to the nuclear facility and directing the radiation detection part toward the nuclear facility by driving the radiation detection part to be inclined back and forth, left and right.

2. The detector of claim 1, wherein the position adjustment unit comprises:
a seating plate on which the radiation detection part is seated on a front side thereof; and
a plurality of directing cylinders configured to connect the unmanned aerial vehicle and the seating plate and to be linearly extendable.

3. The detector of claim 2, wherein each directing cylinder is spaced apart from each other along a rear edge of the seating plate.

4. The detector of claim 3, wherein each directing cylinder is disposed on a circumference having a predetermined radius.

5. The detector of claim 4, wherein one end of each directing cylinder is coupled to one neighboring directing cylinder on side of the unmanned aerial vehicle and extends obliquely, and the other end of each directing cylinder is coupled to another directing cylinder on side of the seating plate.

6. The detector of claim 5, wherein the position adjustment part further comprises:
link parts in which both ends of the directing cylinder are rotatably connected to the unmanned aerial vehicle and the seating plate, respectively.

7. The detector of claim 6, wherein the unmanned aerial vehicle further comprises:
a communication unit configured to wirelessly receive a driving control command of each directing cylinder from the user.
